(19) United States
(12) Patent Application Publication
(10) Pub. No.: US 2005/0076213 A1
(43) Pub. Date: Apr. 7, 2005

(54) Self-enrollment and authentication method

(76) Inventor: James Conlow, Oakland, CA (US)

Correspondence Address: BEESON SKINNER BEVERLY LLP, ONE KAISER PLAZA, SUITE 2360, OAKLAND, CA, 94612, US

(21) Appl. No.: 10/413,861

(22) Filed: Apr. 14, 2003

Related U.S. Application Data
(60) Provisional application No. 60/372,469, filed on Apr. 12, 2002.

(51) Int. Cl. H04L 9/00

(52) U.S. Cl. 713/170

(57) ABSTRACT

A self-enrollment and authentication method provides that, when a user logs onto a host computer and requests that the user's physical identity be verified, a Unique User Identity (UUI) is created to identify the user on the host computer, and a Unique Code Phrase (UCP) is created which is linked with the user's UUI. The UCP is recorded on a document which the user executes before a notary public averring that the user is an identified person. If upon review of the executed document, it is determined that the user's identity has been verified, a Verified Physical Identity (VPI) is established and stored on the host computer and the user's status is upgraded to entitled the user access to reserved privileges on the host computer.

This application claims the benefit of U.S. Provisional Application No. 60/372,469 filed Apr. 12, 2002.

### FIELD OF THE INVENTION

The present invention relates to procedures for self-enrollment onto a computer which include a physical identification process that excludes any use of the computer.

### BACKGROUND OF THE INVENTION

The use of computers and computer networks by organizations to perform transactions for and supply confidential information to numerous persons is now a firmly embedded fixture of our society. Business partners, customers, vendors, and employees need easy access to computer-generated resources and secure and reliable avenues for obtaining critical information from and performing private transactions on a host computer. Transactions commonly performed using computer networks include financial transactions, entry into legal contracts, information retrieval, and virtual conferencing. A potent challenge presented by the explosive proliferation of computer networks has been to assure that persons and entities logging onto host computers are not provided access to critical or private information or resources belonging to others. For example, a financial institution which receives an electronic instruction to transfer funds from an account of the sender to another account has a critical interest in knowing that the sender is authorized to negotiate transactions on the account. It follows that it is of vital importance for an organization to be able to identify each user who logs onto the organization's server as being the particular individual or entity entitled to access hosted resources. Conversely, each individual or entity needs a level of assurance that logging onto a host computer will reliably provide access to that individual's or entity's personal or proprietary information located on the host.

It is frequently impractical or prohibitively expensive to use conventional identification methods, such as examining a person's driver's license or identification card, to authenticate the identity of a person requesting access to a computer network, especially if the person is located remotely from the host computer or if the transaction is being conducted in the evening or at night.

The challenge of authenticating the identities of users, especially remote users, of computer resources has been met by many ingenious and sophisticated solutions. Encryption methods protect the content of communications between linked computers. Password protocols particularly attempt to solve the problem of one party proving to another party that the former knows a password. For example, U.S. Pat. No. 6,539,479 to Wu, discloses a method for establishing a session value by a serial exchange of values between a client computer and a server computer. A login session is established if the server computer verifies that the server and client session keys match. U.S. Pat. 6,079,021 to Abadi discloses a method and apparatus for strengthening passwords by application of a one-way hash function to a concatenation of a password and a password supplement to generate an access code. During operation of the system, a user enters a password, and the one-way hash function is applied to concatenations of the password and possible values having the size of the password supplement to yield trial access codes. Access is granted when one of the trial access codes is identical to the stored access code.

U.S. Pat. No. 6,496,936 to French, et al., discloses a system and method for authentication of network users in which a network user is presented with a hierarchy of queries based on, first, wallet-type and, second, non-wallet-type information. The first set of queries requests that the user provide information commonly carried on the person. The second set of queries requires knowledge of comparatively private information, such as a mortgage loan, typically not carried on a person. The user is awarded different levels of authentication according to the user's ability to respond to the successive queries.

Another method for authenticating users logging onto a computer or a network involves the use of trusted third parties charged with the limited responsibility for verifying the identity of the user. U.S. Pat. No. 6,487,667 to Brown discloses a system for remote pass-phrase authentication in which an authentication “deity” is used to the verify the identities of a user and a service. The user initially communicates with a service that wishes to learn and authenticate the user's identity. Using challenge-response techniques, the user calculates a response and sends it to the service. The service then calculates a response. The service then sends a request to the authentication deity containing a specified realm name, the user's name, the service's name, the user's challenge, the service's challenge, the user's response, and the service's response. The authentication deity knows the user's and service's pass-phrases which, along with the specified information, it uses to verify the identities of the user and of the service. The authentication deity then supplies a random, 128-bit session key for use by the user and the service.

U.S. Pat. Nos. 6,308,277 and 6,035,402 to Vaeth, et al., disclose a method and system for creating and administering virtual certificates digitally signed by a trusted certificate authority to ensure that certificated transactions are authenticated as that of a particular entity. Requests for a certificate, along with verification information, are directed to the certificate authority, where they are held and accessed, and approved or disapproved, by a registration entity having verification responsibilities.

All of the prior art solutions are limited in that they do not sufficiently address the issue of verifying the identity of the user the first time that user logs onto a computer or a network of computers, they depend on a negotiation between the user's computer and the host computer to attempt to verify the user's identity, or they depend on a trusted third party to authenticate the original logon information which may have been created by an impersonator. None of these methods squarely deal with the fact that, once a user initially logs on and establishes an “identity” with a host, the user will thereafter be able to log onto the host and be recognized as having the established identity. If the identity is a fraud at the initial logon, the user will successfully be able to impersonate that identity in all subsequent transactions with the host. No automated mechanism presently exists that can accurately, yet cost-effectively, verify a human being's identity; recognition of a human being by another human being continues to be the most reliable and widely available mode of verifying human identity. Unfortunately, current procedures requiring a prospective user to come to a point of contact so that the user's physical identification documents can be examined, or whereby a company representative is sent to the locale of the user, are expensive, time-consuming, and discouraging to commerce. For example, it may be prohibitively time-consuming to require an individual to travel to a point of contact for the organization operating the computer network so that the individual's photo ID or other identifying documentation may be examined. Similarly, it is generally too expensive for most organizations to send a representative to the individual to accomplish this purpose. Nevertheless, the examination of physical documentation of a person's identity is a reliable indicator that the person is who he purports to be.

### SUMMARY OF THE INVENTION

An improved method for self-enrollment and authentication creates a one-to-one association between a Unique User Identity (UUI) and a Verified Physical Identity (VPI). A UUI is an alphanumeric string unique to the user. Generally, the UUI will be derived from basic identifying information supplied by the user during the logon, and may include a user-created password or pass phrase. The UUI is stored in a memory accessible through the computer network. A VPI is an indication or status created using physical identification procedures which exclude any use of the computer network. Once the VPI is created, stored on the host computer and associated with the UUI, the status of the user is modified to grant upgraded rights.

The method of the invention provides that, at any time after the user logs onto the host computer and that a VPI is requested, a UUI is created and the host generates a Unique Code Phrase (UCP) uniquely associated with the user as represented by the user's UUI. The UCP is also an alphanumeric string, albeit different than the UUI. The host then records the UCP on a document which is provided to the user.

Upon receipt of the document including the UCP, the user presents himself to a notary public. While before the notary public, the user signs a statement on the document averring that the user is an identified individual. The notary public then acknowledges the user's signature on the document, verifying that the user is the indicated individual.

The method provides then that the user returns the document to the organization or entity which operates the host computer. If upon review of the document, the organization determines that the document retains the UCP, that the user has signed the statement on the document, and that the notarial acknowledgment appears proper, the organization may deem the user to have created a VPI. The fact of the VPI is entered, stored on the host computer and associated with the UUI, allowing the user's UUI to be granted an upgraded status carrying entitlement to reserved privileges.

This invention is complementary to prior art authentication processes that protect transactions occurring subsequent to the initial log on of the user. In certain settings it is important that an individual seeking enrollment on a computer network be initially physically identified. Such objective proof is still desirable when dealing with confidential or other sensitive information. The present invention bridges the gap between physical identification procedures and protections afforded by computer-generated verification procedures. By taking advantage of the de facto “distributed network” of notary public officials, the cost to the user and to the organization is minimized. The method effectively authenticates the identity of the user who initially created the UUI, using a process that is easy, inexpensive, and accurate in comparison to prior art authentication techniques.

### BRIEF DESCRIPTION OF THE ILLUSTRATIONS

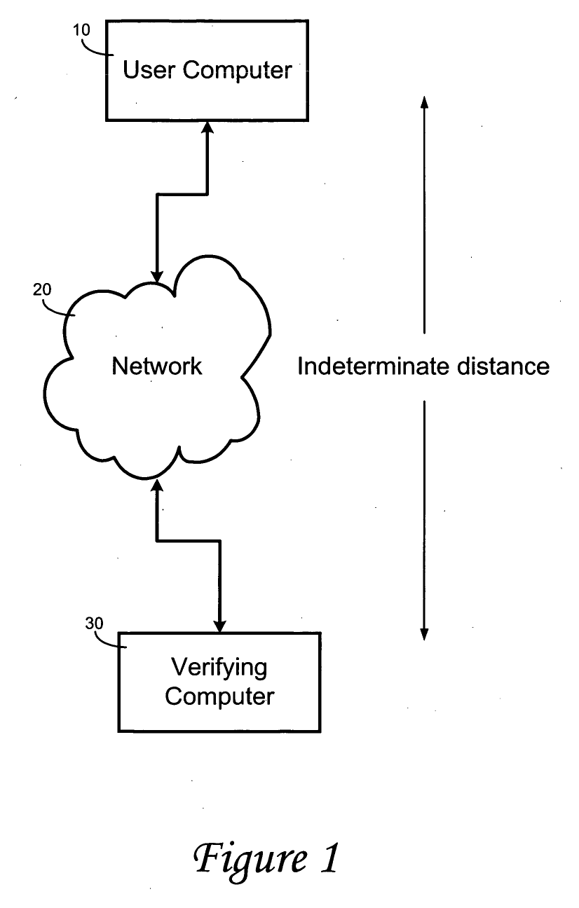

FIG. 1 is a schematic diagram showing the relationship between a user computer and a verifying computer through a network.

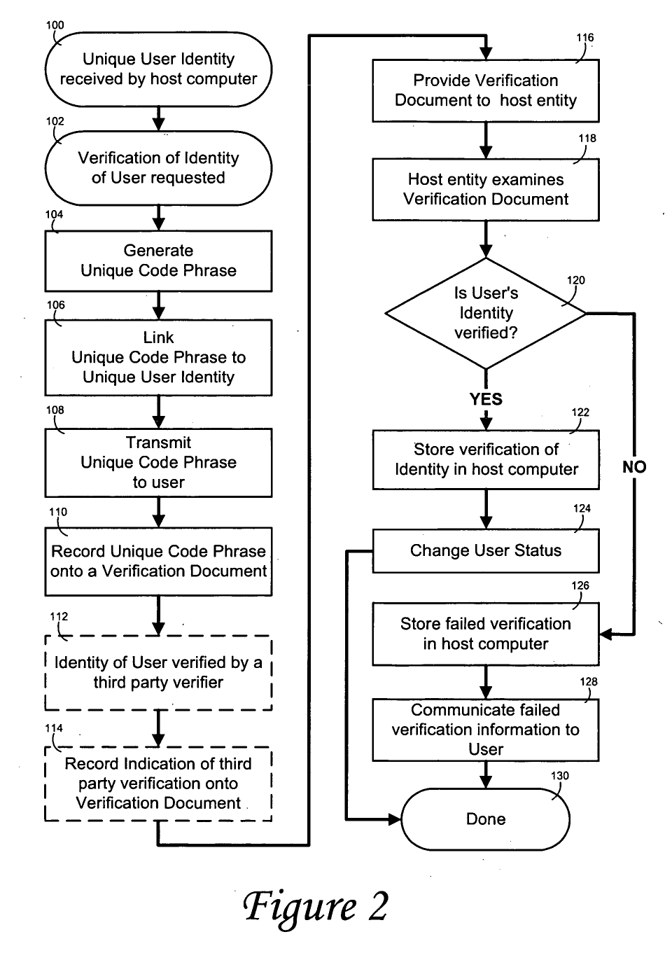

FIG. 2 is a schematic diagram illustrating the steps of a self-enrollment and authentication method according to the invention.

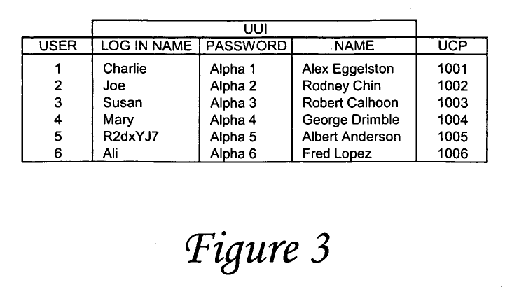

FIG. 3 is a chart showing the progress of several hypothetical users of the method from log on through establishment of a Unique Code Phrase.

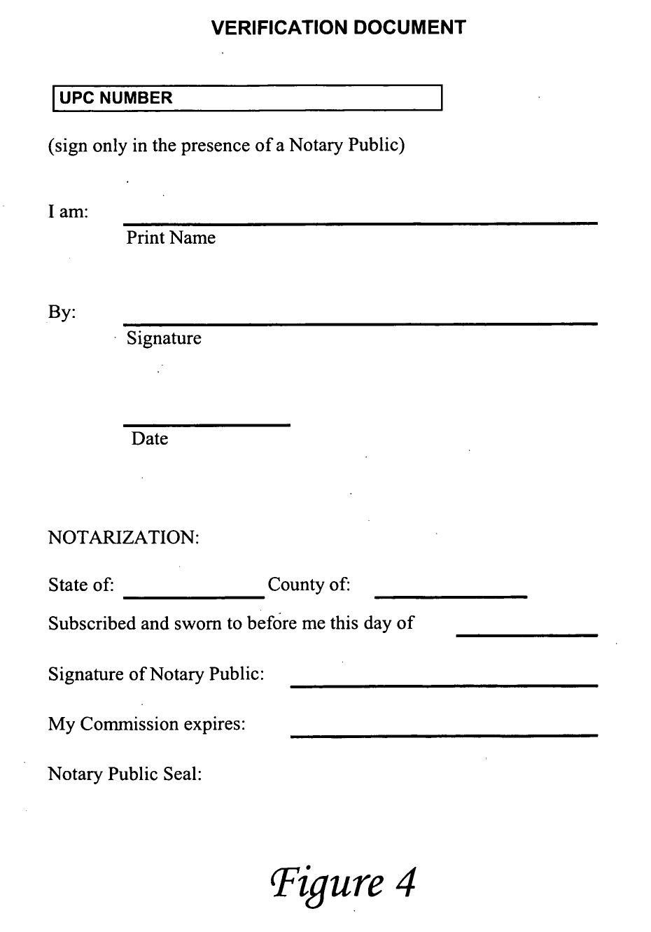

FIG. 4 is representation of a Verification Document according to the invention.

### DETAILED DESCRIPTION OF THE ILLUSTRATED EMBODIMENT

A self-enrollment and authentication method is described below and illustrated in the accompanying drawings according to the invention. The method of the invention is preferably for use between an individual using a user computer 10 who is logged onto a verifying computer 20 through a network of computers 30 wherein the distance between the verifying computer and the user's computer is indeterminate. The method is equally applicable to a computer system in which the user communicates with the verifying computer directly through a terminal.

Referring to FIG. 3, the method is initiated by the user logging onto a host computer and establishing a Unique User Identity (“UUI”), at 100. The UUI preferably is established in a conventional manner by the user inputting a log in name, also known as a user name, for purposes of communicating with the host computer, and creating a password. The UUI may be a combination of the user's logon name and password, or could be any alphanumeric string such as one derived from the user's logon name and password. The mode by which the UUI is established is not central to the invention, so long as the UUI is unique to the user within the realm defined by the host computer.

Many organizations provide a service accessible through their computer networks only if the user enrolls for the service on the network and provides required information. The method of the present invention assumes that an operating requirement of the organization is that each new user must be physically identified before qualifying to participate in restricted transactions on the organization's network. Accordingly, the method provides that the user requests verification of the user's identity, at 102.

Upon receipt of the user's request for verification of identity, the host computer generates a Unique Code Phrase (“UCP”), at 104. The UCP, like the UUI, is an alphanumeric string, but is generated by the host computer. The mode by which the host computer generates the UCP is not important to the invention; the UCP may be generated by many of the methods known to those skilled in the art, e.g., it may be a random number or any alphanumeric string, so long as it is uniquely associated with the user's UUI. Accordingly, at 106, the UCP is linked to the UUI in the host computer. The UCP acts as a unique identifier for the user as represented by the user's UUI and, as discussed below, can be recorded on a document which may be open to public inspection. The UCP is stored in memory along with the fact of its unique link to the UUI.

FIG. 3 is a chart representing a simplified progression by several users from logon to establishment of the UCP. The first user may log on and take the name of “Charlie” and establish the password “Alpha 1.” The first user's actual name may be “Alex Eggelston.” Therefore, the first user's UUI could be “Charlie—Alpha 1—Alex Eggelston” or any other alphanumeric string which may be used to uniquely identify this user whose identity is yet unverified. The computer then creates a UCP for the first user represented by the alphanumeric string “1001.” Similarly, the fifth user takes the name “Chris,” and uses the password “Alpha 5.” This user's real name may be “Albert Anderson.” Thus, the UUI for the fifth user might be “Chris—Alpha 5—Albert Anderson” or another alphanumeric string unique to that user. The computer establishes a UCP for the fifth user represented by the alphanumeric string “1005.”

Referring again to FIG. 3, the UCP is trarismitted to the user at 108. In the preferred embodiment of the method, the UCP will be recorded on a Verification Document printed by the host computer. The Verification Document also includes an averment for signature by the user affirming that he or she is a particularly identified person. Preferably, the averment is in the following form: “I am [name of individual],” immediately followed by a signature line and, preferably, a date. A notarial acknowledgment, in a form appropriate for the state of the user's identified domicile, for acknowledgment of the user's averment, is provided below the averment. The Verification Document is provided to the user for submission to a third party verifier, at 112.

Although the preferred method is for the host computer to print the Verification Document, the UCP alone may be transmitted to the user with instructions to record the UCP, the averment, and a notarial acknowledgment on a document at the user's remote location, thereby constructing a Verification Document at the user's remote location. A second alternative is to e-mail a printable form containing the UCP, averment, and acknowledgment to the user. The basic requirement of the method is that the user sign a document averring that he is who he purports to be, that the document contain the UCP, and that the user's signature be acknowledged by a third party verifier authorized to authenticate a person's identity.

Preferably, the third party verifier is a notary public. However, any third party authorized to officially acknowledge the identity of a signatory would be an acceptable for practicing the method. For example, a consular official in a foreign country could acknowledge the remote user's identity. Preferably, a notary public records the indication of verification of the user's identity onto the Verification Document, at 114. Thereafter, the user returns the Verification Document to the host entity, at 116. After the host entity receives the Verification Document, it must examine it, at 118, to determine if the user's identity has been verified. The most practical method of examination is for an employee of the host entity to examine the document. Alternatively, the host computer may scan a Verification Document preformatted to allow programmed examination of the document by the computer.

The essential issue to be answered upon examination of the document is whether the user's identity is verified, at 120. If the determination is made that the user's identity is verified, the fact of verification of the user's identity is stored in the host computer, at 120, as a Verified Physical Identity (“VPI”) and the user's status is changed, at 124, to upgrade the user's access to privileges and resources reserved for persons having established a VPI. If the user's identity is not verified, the fact of the failure to verify the user's identity is stored in the host computer, at 126, and information regarding the failed verification is communicated back to the user, at 128. In either case, the method is terminated, at 130.

Once the user has established a VPI, every time the user subsequently logs onto the host computer, the user will be entitled to upgraded privileges without the need for going through a verification process at the beginning of each session.

The invention provides a simple and practical solution to the problem of authenticating the identity of a user enrolling on a host computer in a networked environment regardless of the distance between the user and the host.

There have thus been described and illustrated certain preferred embodiments of a self-enrollment and authentication method according to the invention. Although the present invention has been described and illustrated in detail, it is clearly understood that the same is by way of illustration and example only, and is not to be taken by way of limitation, the spirit and scope of the present invention being limited only by the terms of the appended claims and their legal equivalents.

1. A method for remote enrollment by and verification of the identity of a user on a host computer, the method comprising:
receiving identifying information from a user, said identifying information unique to said user on the host computer,
creating unique linking data,
associating said linking data with said identifying information,
providing said linking data to said user,
receiving a document from said user containing said linking data,
verifying that said document includes a statement averring that said user is a person, and
verifying that said statement has been executed by said person before another authorized to verify the identity of a signatory.

2. The method for enrollment as recited in claim 1 further comprising:
receiving from said user a request to verify said user's identity.

3. The method for enrollment as recited in claim 1 wherein:
said identifying information includes said person's name.

4. The method for enrollment as recited in claim 1 wherein:
said person is a business entity.

5. The method for enrollment as recited in claim 1 wherein:
said identifying information includes a unique password.

6. The method for enrollment as recited in claim 1 wherein:
said user requests enrollment of said user on the host computer.

7. The method for enrollment as recited in claim 1 wherein:
said unique linking data comprises an alphanumeric identifier.

8. The method for enrollment as recited in claim 1 wherein:
said unique linking data comprises a unique code phrase.

9. The method for enrollment as recited in claim 1 further comprising:
generating said document, said document containing said linking data, and providing said document to said user.

10. The method for enrollment as recited in claim 1 further comprising:
transmitting instructions for generation of said document to said user.

11. The method for enrollment as recited in claim 1 wherein:
generation of said document includes providing said statement on said document.

12. The method for enrollment as recited in claim 1 further comprising:
executing said document by said person before another authorized to verify the identity of a signatory.

13. The method for enrollment as recited in claim 1 further comprising:
storing an indication that said user is said person, and
authorizing recognition of said user as said person.

14. The method for enrollment as recited in claim 1 further comprising:
storing an indication that said user's identity has been verified, and
changing said user's status to upgrade said user's access to resources on the host computer.

15. The method for enrollment as recited in claim 13 further comprising:
verifying that said document retains said linking data.

16. The method for enrollment as recited in claim 1 wherein:
said another authorized to verify the identity of a signatory is a notary public.

17. The method for enrollment as recited in claim 1 further comprising:
creating a unique user identity responsive to receipt of said new identifying information from said user.

18. A method for remote enrollment by and verification of the identity of a user on a host computer, the method comprising:
receiving identifying information from a user, said identifying information unique to said user on the host computer,
creating unique linking data,
associating said linking data with said identifying information,
generating a document containing said linking data, said document including a statement averring that said user is said person providing said document to said user,
executing said document by said person before another authorized to verify the identity of a signatory,
receiving said document from said user,
verifying that said document includes said statement,
verifying that said statement has been executed by said person before said another authorized to verify the identity of a signatory,
storing an indication that said user is said person, and
authorizing recognition of said user as said person responsive to receipt of a subsequent transmission from said user.

19. The method for enrollment as recited in claim 18 further comprising:
changing said user's status to provide said user upgraded access to resources on the host computer.

20. An apparatus for remote enrollment by and verification of the identity of a user on a host computer, the apparatus comprising:
a memory for storing identifying information related to one or more users,
one or more network interfaces adapted to send and receive data to and from usernodes,
one or more processors in communication with said memory, and
one or more secure interfaces in communication with said processor,
wherein, when said one or more network interfaces receive from a user identifying information unique to said user on the host computer, said one or more processors store said identifying information in said memory, and create unique linking data associated with said identifying information, and said one or more network interfaces send said linking data to said user, and
wherein, when said one or more secure interfaces receive verification that a document containing said linking data and a statement averring that said user is a person has been executed before another authorized to verify the identity of a signatory, said one or more processors store in said memory an indication that said user is said person.

21. The apparatus for enrollment of claim 20 wherein:
when said one or more secure interfaces receive verification that said document has been so executed, said one or more processors provide said user upgraded access to resources on the host computer.

22. The apparatus for enrollment of claim 20 wherein:
when said one or more network interfaces receive a transmission from said user subsequent to storing said indication in said memory that said user is said person, said one or more processors authorizes recognition of said user as said person.

23. The apparatus for enrollment of claim 20 wherein:
said identifying information includes said person's name.

24. The apparatus for enrollment of claim 20 wherein:
said identifying information includes a request for enrollment of said person on a network.

25. The apparatus for enrollment of claim 20 wherein:
when said one or more network interfaces receive from a user identifying information including indicia identifying a person, said one or more processors create a unique user identity from said identifying information.

26. The apparatus for enrollment of claim 20 wherein:
said unique linking data comprises a unique code phrase.

27. The apparatus for enrollment of claim 20 further comprising:
a scanner in communication with said one or more processors,
wherein, when said document is scanned by said scanner, said one or more processors verify that said document retains said linking data.

28. The apparatus for enrollment of claim 27 wherein:
wherein, when said document is scanned by said scanner, said one or more processors recognizes an acknowledgment of a notary public.

29. A computer program product comprising a machine readable medium on which is provided program instructions for performing a method for remote enrollment by and verification of the identity of a user on a host computer using another computer in communication with the host computer, the program instructions comprising:
program code for receiving identifying information from a user, said identifying information unique to said user on the host computer,
program code for creating unique linking data,
program code for associating said linking data with said identifying information,
program code for generating a document containing said linking data and a statement averring that said user is a person,
program code for storing an indication that said user is said person responsive to a verification that said statement on said document has been executed by said user before another authorized to verify the identity of a signatory, and
program code for authorizing recognition of said user as said person responsive to receipt of a subsequent transmission from said user.

30. The computer program product as recited in claim 29 further comprising:
program code for upgrading said user's access to resources on the host computer.

31. The computer program product as recited in claim 29 further comprising:
program code for verifying that said document has been executed before another authorized to verify the identity of a signatory.

32. The computer program product as recited in claim 29 further comprising:
program code for creating a unique user identity from said identifying information.

33. The computer program product as recited in claim 29 further comprising:
program code for reading said document to verify that said document retains said linking data.

34. The computer program product as recited in claim 33 further comprising:
program code for recognizing an acknowledgment of a notary public.
